(19) United States
(12) Patent Application Publication
(10) Pub. No.: US 2007/0215177 A1
(43) Pub. Date: Sep. 20, 2007

(54) Method for Cleaning Object to Be Cleaned and Apparatus Therefor

(76) Inventor: Masahide Uchino, Tokyo (JP)

Correspondence Address: JORDAN AND HAMBURG LLP, 122 EAST 42ND STREET, SUITE 4000, NEW YORK, NY, 10168, US

(21) Appl. No.: 11/596,203

(22) PCT Filed: Apr. 27, 2005
(86) PCT No.: PCT/JP05/08011

§ 371 Date: Dec. 28, 2006

(30) Foreign Application Priority Data
May 11, 2004 (JP) 2004-141562
Aug. 31, 2004 (JP) 2004-252505

(51) Int. Cl. B08B 7/04; B08B 3/00; B08B 3/12

(52) U.S. Cl. 134/10; 134/34; 134/184; 134/109

(57) ABSTRACT

A cleaning operation is repeatedly performed by constantly cleaning an object to be cleaned by a cleaning mechanism. When the cleaning operation from an initial step to completion can be performed with one type of cleaning solution, the same cleaning effects as those obtained when a plurality of cleaning tanks are used can be obtained on the object to be cleaned by using a single cleaning tank. A storing body can store an object to be cleaned. A cleaning solution can be stored in the storing body under the condition where the storing body is placed on a working table. The cleaning solution can be discharged when the storing body shifts its position from a placing part.

### BACKGROUND OF THE INVENTION

The present invention relates to a cleaning apparatus and cleaning method for cleaning objects such as electronic products, mechanical products, medical products, and the like that have become contaminated and is particularly effective in a case where precision cleaning of an object to be cleaned is executed.

Conventionally, in a case where precision immersion cleaning of the object to be cleaned is executed using a cleaning liquid, as shown in Patent Documents 1-3, the object to be cleaned is cleaned while sequentially being moved through multiple cleaning baths. If, as described above, cleaning is executed while the object is sequentially moved through multiple cleaning baths, the cleaning is precise enough to go through many cleaning baths because a primary cleaning can be executed in a first cleaning bath and a secondary cleaning can be executed in a second cleaning bath.

In a method for cleaning the object to be cleaned while the object is sequentially moved through multiple cleaning baths, however, the object to be cleaned contaminates the cleaning bath every time the object to be cleaned is introduced into the cleaning bath. In a case where the object to be cleaned is cleaned by being passed through many cleaning baths, the cleaning liquids of the cleaning baths sequentially become contaminated, doing nothing more than thinning the contaminants, which is not desirable for precision cleaning and is uneconomical because it becomes necessary to frequently replace the cleaning liquid. In addition, upon one execution of the cleaning operation in the cleaning bath of one object to be cleaned, the efficiency of the operation tends to be poor because it is necessary to move the object to the next cleaning bath.
Patent Document 1: Japanese Patent Application Publication No. 2002-177904
Patent Document 2: Japanese Patent Application Publication No. Hei7-136603
Patent Document 3: Japanese Patent Application Publication No. Showa56-108884

### SUMMARY OF THE INVENTION

The present invention solves the problems described above and, in a case where cleaning is possible with one type of cleaning liquid from the beginning of the cleaning operation until the completion, a cleaning effect can be achieved for the object to be cleaned identical to using a single cleaning bath for multiple cleanings. Further, because precision cleaning can be executed in a single cleaning bath, the cleaning operation can be executed quickly without needing steps such as moving the object to be cleaned. In a case where different types of cleaning liquid or similar types of cleaning liquid having different degrees of purity are used in the cleaning process, where different cleaning liquids are used, multiple cleaning baths or operation platforms are necessary, multiple cleanings of the object to be cleaned are possible using one type of cleaning liquid, and high precision cleaning can be executed.

To solve the problems described above, the present invention has a feature that holds a storage unit, formed having an drain capable of draining out the cleaning liquid in a lower portion, on a mounting unit of an operation platform, contacts in an tightly contacting manner at least an external lower portion of the drain of the storage unit with the mounting unit of the operation platform, moves the storage unit from the mounting unit after the object to be cleaned is stored inside the storage unit and cleaned by the cleaning liquid along with the cleaning liquid being storable in the storage unit in a condition where the storage unit is mounted on the mounting unit, dissolves the tight contact between the external lower portion of the drain and the mounting unit, drains out the cleaning liquid from the drain, and repeats the cleaning of the object to be cleaned by introducing the new cleaning liquid into the storage unit and once again contacting the object to be cleaned to the cleaning liquid after the storage unit is returned to the mounting unit.

Further, in the present invention, along with forming the drain that can drain out the cleaning liquid at a lower portion of the storage body that can store the object to be cleaned, at least an external periphery of the lower portion of the drain of the storage unit contacts a mounting unit of an operation platform in a tightly contacting manner, along with being able to store the cleaning liquid inside the storage unit in a condition such that the storage unit is mounted on the mounting unit, the tight contact between the external lower portion of the drain and the mounting unit is dissolved at a time when the storage unit is moved from the mounting unit, the cleaning liquid is drained out of the drain, the storage unit is returned to the mounting unit after the cleaning liquid is drained out, and a new cleaning liquid can be introduced into the storage unit.

The new cleaning liquid may be made to flow by a liquid pump connected via the purification mechanism to the reservoir of drained cleaning liquid, and the cleaning liquid is purified by the purification mechanism and reused.

The new cleaning liquid is not necessarily cleaning liquid purified after being used to clean the object to be cleaned, but rather may be cleaning liquid that has yet to be used.

The operation platform may be statically disposed with installation inside a containment bath serving as the reservoir for storing the cleaning liquid drained from the drain of the storage unit.

The operation platform may be formed independently from the reservoir in a movable manner and may be movable to the location of the reservoir.

The reservoir may be formed of multiple independent units filled with different cleaning liquids corresponding to respective cleaning objectives, and the storage unit may be sequentially connected to the multiple reservoir units, while the cleaning liquid may be supplied to the object to be cleaned by a pump.

On the operation platform, an ultrasonic oscillator may be disposed on the mounting unit of the storage unit and, along with the cleaning liquid, the object to be cleaned that is stored in the storage unit can be ultrasonically cleaned.

A roller having a diameter larger than a height of an external peripheral frame dividing the multiple successive operation platforms may be disposed on the upper surface of the operation platform, and the object to be cleaned can be moved by the roller.

The object to be cleaned that is stored in the storage unit may be inserted into a storage basket.

Because the present invention is structured as described above, if the cleaning liquid is filled along with storing the object to be cleaned inside the storage unit mounted on the mounting unit of the operation platform, the object to be cleaned inside the storage unit can be cleaned without externally draining out the cleaning liquid because the external lower portion of the drain equipped on the lower portion of the storage unit contacts the upper surface of the mounting unit in a tightly contacting manner. After the cleaning is completed, if the storage unit is moved from the mounting unit by a method such as raising up or horizontally moving the storage unit, the tight contact between the external lower portion of the drain and the upper surface of the mounting unit can be dissolved. By dissolving the tight contact, the cleaning liquid is quickly drained from the drain, the storage unit is returned to the mounting unit, and, because the cleaning liquid can again be introduced, the object to be cleaned can once again be cleaned by again introducing the cleaning liquid into the storage unit on the upper surface of the operation platform.

In the present invention, because the object to be cleaned can be repeatedly cleaned, in a case where the object can be cleaned from the beginning of the cleaning operation until the completion by one type of cleaning liquid, a cleaning effect can be achieved for the object to be cleaned identical to using a single cleaning bath for multiple cleanings. Because precision cleaning can be executed in a single cleaning bath, the cleaning operation can be executed quickly without needing steps such as moving the object to be cleaned between multiple cleaning baths.

In a case where different types of cleaning liquid or similar types of cleaning liquid having different degrees of purity are used in the cleaning process, where different cleaning liquids are used, multiple cleaning baths are necessary, multiple cleanings of the object to be cleaned can be repeated using each type of cleaning liquid, and high precision cleaning can quickly and easily be executed.

Further, the storage unit can be cylindrical as long as it can achieve a watertight hold on the upper surface of the operation platform, thereby being comparatively much cheaper than a usual cleaning bath.

### BRIEF DESCRIPTION OF THE DRAWINGS

FIG. 1 is a flow chart showing the first embodiment;

FIG. 2 is a flow chart showing the cleaning operation condition of the first embodiment;

FIG. 3 is a flow chart showing the movement condition of the storage unit in the first embodiment;

FIG. 4 is a perspective view of the storage unit;

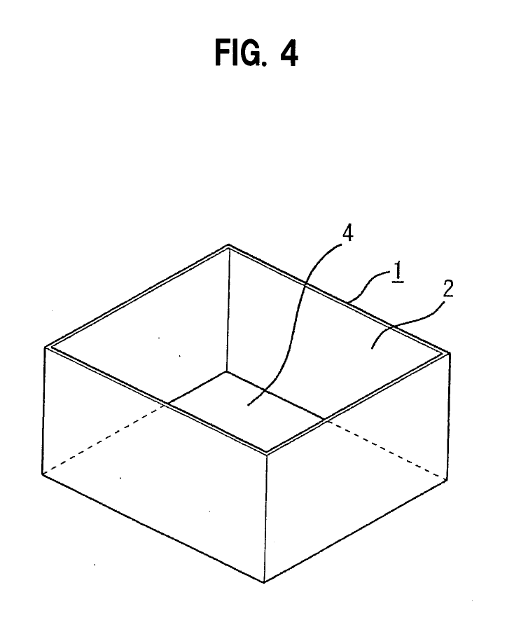

FIG. 5 is a perspective view showing one example of the storage basket;

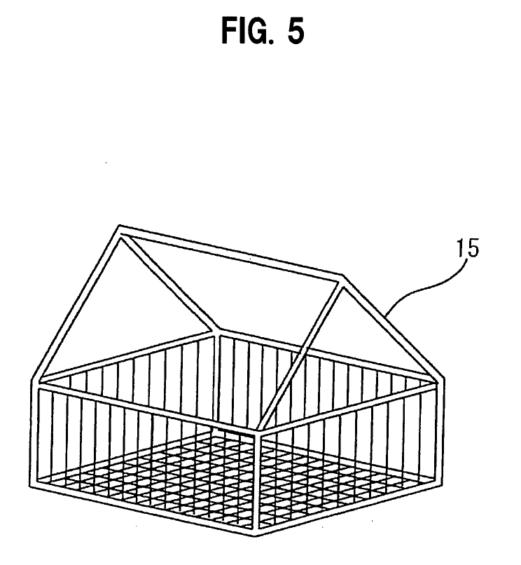

FIG. 6 is a perspective view showing a different embodiment of the storage unit;

FIG. 7 is a flow chart showing the second embodiment;

FIG. 8 is a flow chart showing the condition of multiple reservoirs being used in the second embodiment;

FIG. 9 is a flow chart showing the condition of a roller being used on the operation platform in the third embodiment;

FIG. 10 is a flow chart showing the fourth embodiment;

FIG. 11 is a flow chart showing the cleaning operation condition of the fourth embodiment;

FIG. 12 is a flow chart showing the condition of the storage unit being moved in the fourth embodiment;

FIG. 13 is a schematic diagram showing an example of the storage unit with different measurements being used in the fifth embodiment; and

FIG. 14 is a plain view of FIG. 13.

### EXPLANATION OF THE NUMBERING

1 storage unit

3 cleaning liquid

4 drain

5 operation platform

6 mounting unit

7 reservoir

8 containment bath

11 purification mechanism

12 liquid pump

14 ultrasonic oscillator

17 external peripheral frame

23 roller

24 object to be cleaned

### DETAILED DESCRIPTION OF THE INVENTION

### First Embodiment

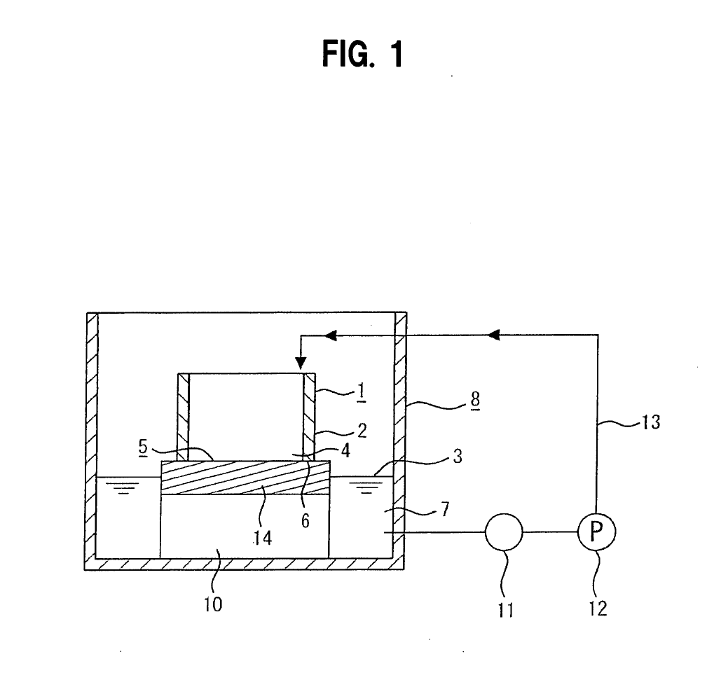

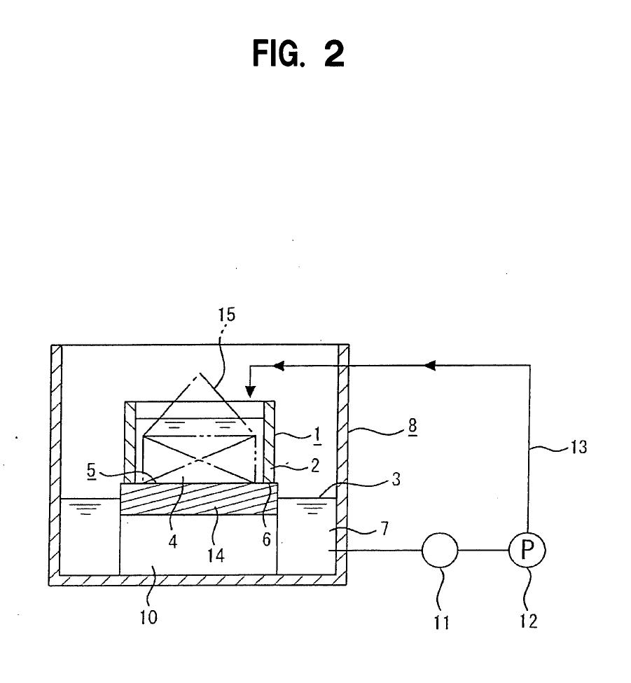

Described according to the diagram of the first embodiment of the present invention, (1) is a storage unit and, along with forming an external wall having sufficient size to store the object to be cleaned, such as an electronic product, mechanical product, or medical product, also forms a drain (4) capable of draining out the cleaning liquid (3), as shown at the bottom of FIG. 1 and FIG. 2. The drain (4) may open at a bottom plate of the storage unit (1), but in the embodiment shown in the diagram the storage unit (1) is not equipped with the bottom plate and the lower portion serves as the drain (4). With the storage unit (1) being mounted on the mounting unit (6) of the operation platform (5) on which the cleaning operation is performed, the lower portion of the external wall (2) forming the drain (4) is attached in a tightly contacting manner to the mounting unit (6).

The tight contact is not strictly set, and the cleaning liquid (3) stored inside the storage unit (1) may be any substance that can be contained by the tight contact and mounted inside the storage unit (1) until one cycle of the cleaning operation is completed, and some of the cleaning liquid (3) may be drained out as long as there is no interference in one cycle of the cleaning operation. In addition, the tight contact of the mounting unit (6) to the lower portion of the external wall (2) forming the drain (4) may be formed in a mirror-like manner in the lower portion of the external wall (2) and the mounting unit (6), may use liquid-tight packing, and can use any arbitrary method.

A placement platform (10) is set up in a containment bath (8) equipped with a reservoir (7) for storing the cleaning liquid (3) drained from the drain (4) of the storage unit (1), and the operation platform (5) is set up inside the containment bath (8) by being disposed on the upper surface of the placement platform (10). In addition, a liquid pump (12) is connected to the reservoir (7) via a purification mechanism (11) for purifying the cleaning liquid (3). The purification mechanism can use a filter, an ion exchange mechanism, an oily water separator, or a purification recycling mechanism. The cleaning liquid (3) made to flow by the liquid pump (12) and purified by the purification mechanism (11) can be introduced by an introduction pipe (13) into the storage body (1) disposed on the upper surface of the operation platform (5).

On the operation platform (5), an ultrasonic oscillator is disposed on the mounting unit (6) of the storage unit (1) and the object to be cleaned that is stored in the storage unit (1), along with the cleaning liquid (3), can be ultrasonically cleaned. Methods other than ultrasonic cleaning such as bubble cleaning and oscillating cleaning methods can of course be used as a supplementary cleaning method for the object to be cleaned by the cleaning liquid.

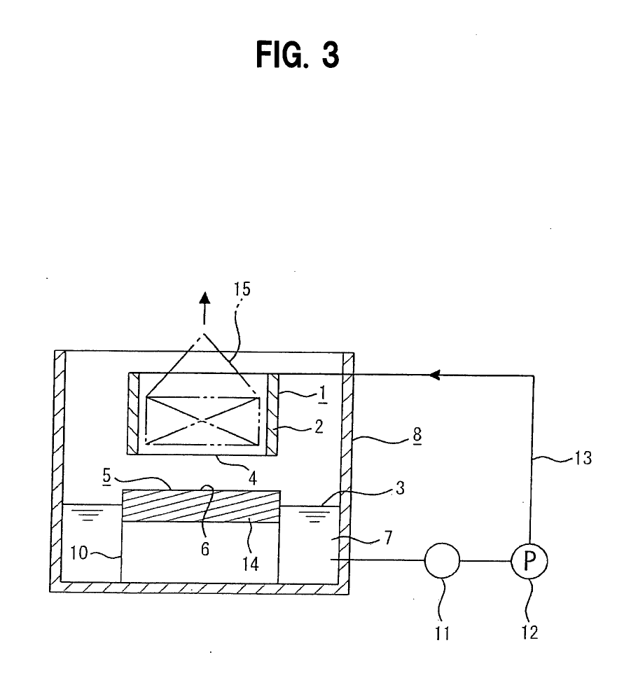

The cleaning of the object to be cleaned is executed with the object stored in the storage unit (1) and the object to be cleaned may be directly stored in the storage unit (1) and directly mounted on the mounting unit (6), but also, as shown in FIG. 2 and FIG. 3, a cleaning basket (15) may be stored in the storage unit (1) after the object to be cleaned is stored in the cleaning basket (15) formed separately from the storage unit (1). The method of directly storing the object to be cleaned in the storage unit (1) is effective in a case where high precision cleaning of the object to be cleaned is executed with as little contact as possible with another part. The method of storing the object to be cleaned in the cleaning basket (15) before cleaning and storing the object in the storage unit (1) has the benefit of easy handling in a case where a large number of small objects are to be cleaned. In addition, this method is beneficial in a case where different types of cleaning liquids or similar types of cleaning liquids having different degrees of purity are used in the cleaning process of one type of object to be cleaned, a case where the object is cleaned with multiple different types of cleaning liquid (3), and a case where the object is moved through multiple reservoirs (7) storing multiple types of cleaning liquid (3).

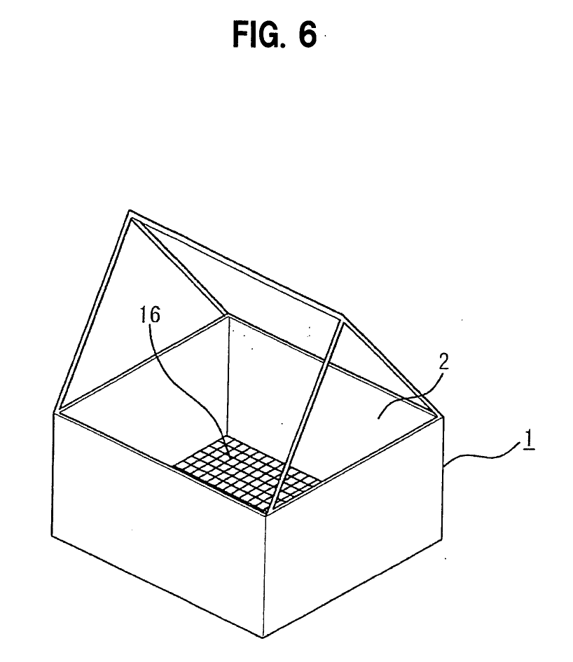

Further, without using the separate cleaning basket (15), the lower portion of the storage unit (1) may be equipped with netting (16) such as a metallic net as shown in FIG. 6.

In the aforementioned construction, in the cleaning of the object to be cleaned, as shown in FIG. 1, the storage unit (1) is mounted on the mounting unit (6) of the operation platform (5). The storage unit (1) is mounted in a tightly contacting manner contacting at least the external lower portion of the drain (4) of the storage unit (1) and the upper surface of the operation platform (5). After the object to be cleaned is stored in the storage unit (1), the liquid pump (12) is activated and the cleaning liquid (3) of the reservoir (7) is introduced via the introduction pipe (13) into the storage unit (1) to contact the object to be cleaned, as shown in FIG. 2. Extremely little or no cleaning liquid (3) filling the storage unit (1) is drained outside because the external lower portion of the drain (4) of the storage unit (1) is adhered to the upper surface of the operation platform (5).

The primary cleaning of the object to be washed is executed in a condition where the cleaning liquid (3) is stored in the storage unit (1), and the ultrasonic oscillator (14) of the placement platform (10) is activated as necessary and ultrasonic cleaning of the object to be cleaned is executed. In addition, an arbitrary supplementary cleaning section other than the ultrasonic oscillator (14), such as a bubble generation section, a vertical swinging section, or a rotating section, for example, may be established on the placement platform (10).

By raising up or laterally moving the object to be cleaned upon completion of the primary cleaning, as shown in FIG. 3, the tight contact between the mounting unit (6) of the operation platform (5) and the exterior of the drain (4) of the storage unit (1) is dissolved. By moving the location of the storage unit (1), the cleaning liquid (3) inside the storage unit (1) is drained from the drain (4) of the storage unit (1) and introduced into the reservoir (7).

After the cleaning liquid (3) is drained out, the storage unit (1) is again mounted on the mounting unit (6) of the operation platform (5), the liquid pump (12) is activated after the drain (4) is sealed, and the cleaning liquid (3) is input from the reservoir (7). Because the purification mechanism (11) for the cleaning liquid (3) such as a filter, ion scaler, or the like is disposed in the space between the reservoir (7) and the liquid pump (12), the cleaning liquid (3) contaminated by the primary cleaning is filled into the storage unit (1) having been purified by the purification mechanism (11). The secondary cleaning operation for the object to be cleaned can then be executed. After completion of the secondary cleaning, the storage unit (1) is moved and the contaminated cleaning liquid (3) is input into the reservoir (7).

By repeating the aforementioned operation a necessary number of times, the object to be cleaned can always be consecutively cleaned by purified cleaning liquid and precision cleaning can quickly be executed.

### Second Embodiment

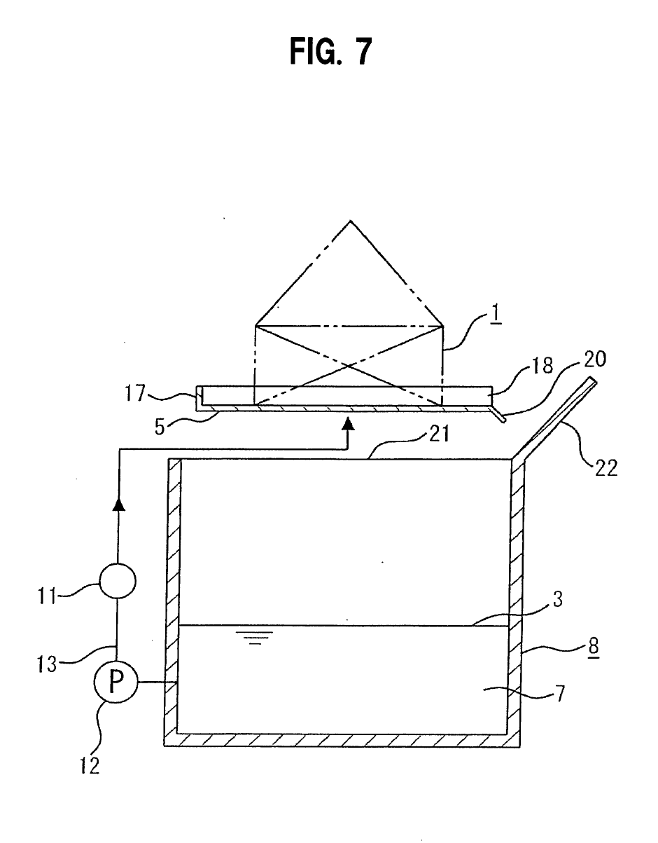

In the first embodiment described above, the reservoir (7) is formed within the containment bath (8) affixed and stored on the operation platform (5), but the reservoir (7) may also be independently formed and separated from the operation platform (5). In the second embodiment, as shown in FIG. 7, along with equipping the external peripheral frame (17) on three external sides of the operation platform (5), an evacuation opening (18) for the cleaning liquid is formed on a side not equipped with the external peripheral frame (17). Under the evacuation opening (18) a guiding piece (20) for draining out the cleaning liquid (3) in one direction is formed.

In the reservoir (7), a liquid receiving piece (22) juts out from the upper portion of the entrance portion (21) facing the guiding piece (20) and the cleaning liquid (3) is stored internally. In addition, the cleaning liquid (3) is connected to the liquid pump (12) and the cleaning liquid (3) purified by the purification mechanism (11) can be introduced into the storage unit (1) mounted on the upper surface of the operation platform (5), in the same manner as the first embodiment.

In the second embodiment formed as described above, during execution of the cleaning operation for the object to be cleaned, along with mounting the storage unit (1) on the mounting unit of the operation platform (5), the object to be cleaned is stored inside the storage unit (1), the operation platform (5) is disposed on the upper surface of the reservoir (7) by an arbitrary mounting method, and the guiding piece (20) of the operation platform (5) faces opposite to the liquid receiving piece (22) of the reservoir (7). In addition, the liquid pump (12) is activated after the cleaning liquid (3) is supplied into the storage unit (1) and the cleaning operation is performed for the object to be cleaned and, if the storage unit (1) is moved, the cleaning liquid (3) inside the storage unit (1) is drained from the storage unit (1) through the evacuation opening (18) on the upper surface of the operation platform (5) and runs into the liquid receiving piece (22) of the reservoir (7), thereby being introduced into the reservoir (7). After the storage unit (1) again tightly contacts to the mounting unit (6) of the operation platform (5), precision cleaning can be executed by activating the liquid pump (12) and repeating the supply of the cleaning liquid (3) purified by the purification mechanism (11) into the storage unit (1).

Cleaning of the object to be cleaned may be executed using one type of cleaning liquid (3) as in the first embodiment, but the aforementioned cleaning method is also beneficial in a case where different types of cleaning liquids or similar types of cleaning liquids having different degrees of purity are used in the cleaning process, a case where the object is cleaned with multiple different types of cleaning liquid (3), or a case where further effects of high precision cleaning are achieved by cleaning the object to be cleaned with multiple cleaning liquids (3) through sequentially connecting the storage unit (1) to reservoirs (7) storing various types of different cleaning liquids (3).

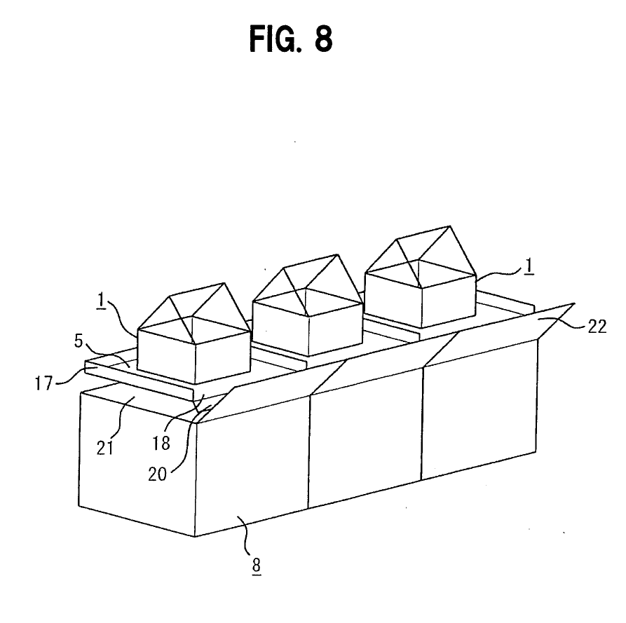

In this embodiment that cleans the object to be cleaned with multiple cleaning liquids (3), as shown in FIG. 8, the reservoirs (7) are individually formed, the cleaning liquid (3) formed from a cleaning agent is stored in the first reservoir (7), a rinsing fluid is used as the cleaning liquid (3) in the second reservoir (7), and pure water is finally used in the third reservoir (7). The types of cleaning liquid (3) used in the multiple reservoirs (7), the number of reservoirs (7), and the like can be arbitrarily decided to correspond to the respective cleaning objectives. Further, from the first reservoir (7) to the third reservoir (7), the same type of cleaning liquid is used, but the cleaning liquid may also be the cleaning liquid (3) of a different degree of purity. In such a case, the purification mechanisms (11) connected to the second and third reservoirs (7) are more highly efficient than the purification mechanism (11) connected to the first reservoir (7) and may be a system capable of filtering the cleaning liquid (3) having a high degree of purity.

In the embodiment shown in FIG. 8, multiple reservoirs (7) are joined together to form a single body, but may also each be equipped independently. The manufacturing cost of a unit can be reduced by joining together the multiple reservoirs (7). In a case where multiple independent reservoirs (7) are used, the cost of a unit increases but a single type of each independent reservoir (7) can freely correspond to a number of uses, placement structure, or the like and, along with being able to easily correspond to the cleaning objective, can have reduced cost through the merits of mass production.

### Third Embodiment

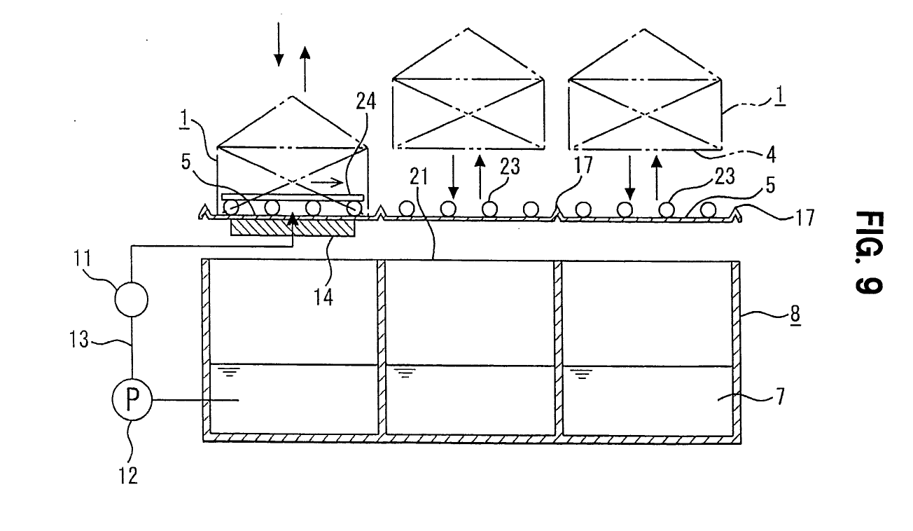

In the aforementioned first and second embodiments, in a case where multiple containment baths (8) are used, the object to be cleaned (24) is stored in the storage unit (1) via the cleaning cage (15) by forming the netting (16) on the lower portion of the storage unit (1), thereby making movement of the object to be cleaned (24) easy to achieve. However, in a case where the object to be cleaned (24) is an easily damaged glass plate, a silicon wafer requiring delicate cleaning, or the like, the first and second embodiments are not necessarily preferable. Therefore, as shown in the third embodiment in FIG. 9, a roller (23) having a circumference larger than the height of the external peripheral frame (17) dividing the multiple successive operation platforms (5) is disposed on the upper surface of the operation platform (5). The object to be cleaned (24) can be moved from a primary cleaning platform (5) to the adjacent cleaning platform without additional shock by having the object to be cleaned (24) moved by the roller (23).

In the third embodiment, with the object to be cleaned (24) mounted on the roller (23) of the operation platform (5), the upper surface of the storage unit (1) tightly contacts the lower portion of the operation table (5), the cleaning liquid (3) is introduced into the storage unit (1) to execute cleaning of the object to be cleaned (24), and, after the storage unit (1) is moved and the cleaning liquid (3) is drained out, the returning of the cleaning liquid (3) into the storage unit (1) via the purification mechanism (11) is repeated multiple times, in the same manner as in the first and second embodiments.

### Fouth Embodiment

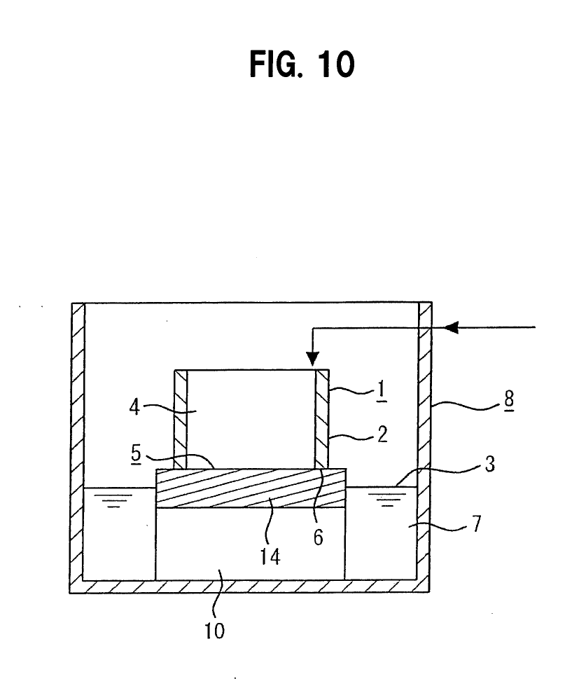

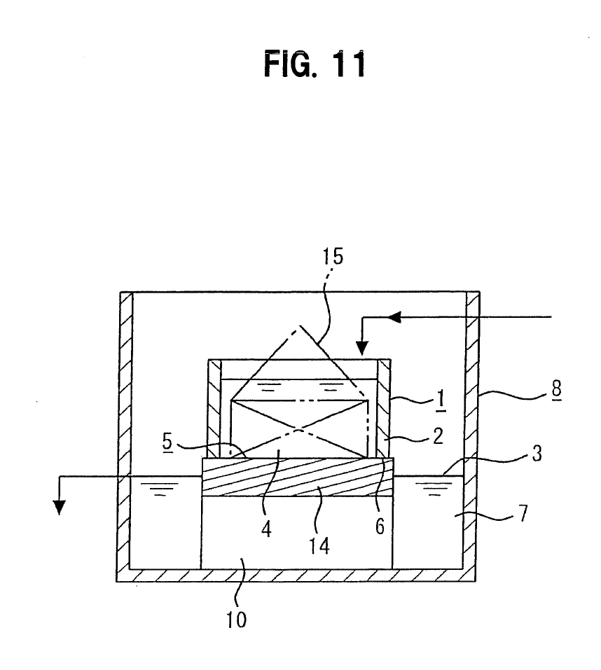

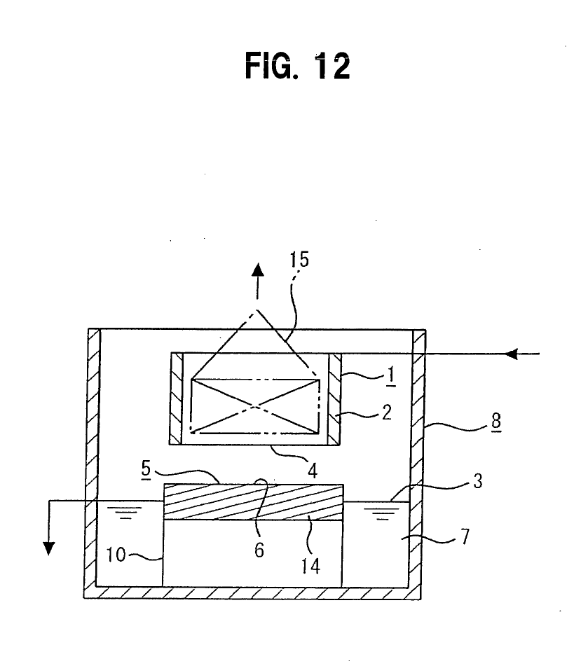

In the first through third embodiments, after being used to clean the object to be cleaned (24), the cleaning liquid (3) is purified using both the purification mechanism (11) and the liquid pump (12) to be reused. However, in the fourth embodiment, which is different, the cleaning liquid (3) is used with the waste of one cleaning of the object to be cleaned (24) discharged, without being purified. In such a case, as shown in FIG. 10, FIG. 11, and FIG. 12, the purification mechanism (11) is not equipped. In a case of high precision cleaning of a semiconductive wafer or the like as a suitable object to be cleaned using this cleaning method, the cleaning operation is executed with pure water being discharged. In such a case, the semiconductive wafer, serving as the object to be cleaned, is stored in the storage unit (1), the cleaning liquid (3), which is pure water, is filled into the storage unit (1), and, after the ultrasonic oscillator (14) is activated and ultrasonic cleaning is executed, the storage unit (1) is moved and the cleaning liquid (3) is drained out. The storage unit (1) is then returned to its original position, new pure water is once again filled into the storage unit (1), and the execution of ultrasonic cleaning is repeated.

Another cleaning method, as in a case where agricultural produce is cleaned with normal water as the cleaning liquid, is an effective cleaning method in a case such as where even though the contaminants of the object to be cleaned are easily discharged with the cleaning liquid, the effect on the environment is small. In such a case, the agricultural produce serving as the object to be cleaned is stored inside the storage unit (1), the cleaning liquid (3), which is normal water, is filled into the storage unit (1), and, after the ultrasonic oscillator (14) is activated and ultrasonic cleaning is executed, the storage unit (1) is moved and the cleaning liquid (3) is drained out. The storage unit (1) is then returned to its original position, the cleaning liquid (3) is once again filled into the storage unit (1), and the execution of ultrasonic cleaning is repeated in the same manner as all of the embodiments.

### Fifth Embodiment

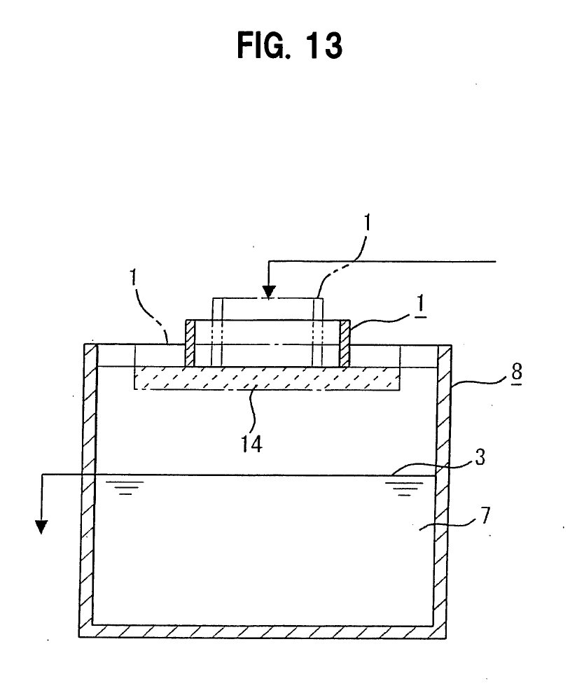

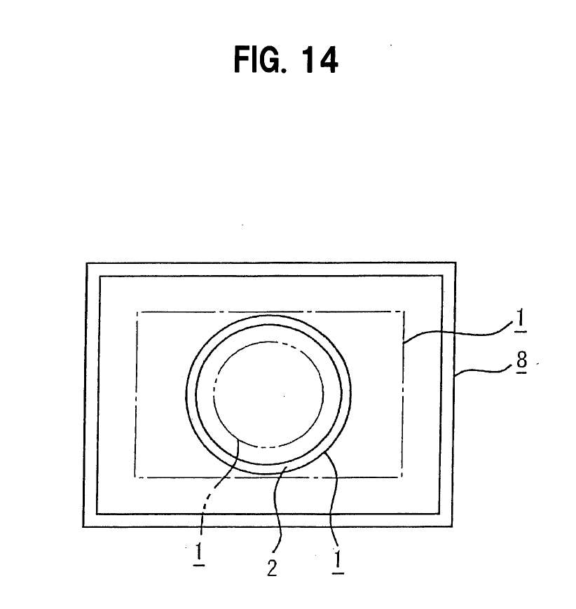

Concerning the dimensions, diameter, and the like of the storage unit (1) mounted on the operation platform (5), any object can be used if it can be mounted on the operation platform (5). For example, setting the storage unit (1) shown by a solid line in FIG. 13 and FIG. 14 as the objective, an object with a large diameter may be used as shown by a single-dot chain line and an object with deep longitudinal diameter may also be used as shown by a double-dot chain line. The selection of the aforementioned type of storage unit (1) can be arbitrarily made corresponding to the cleaning objective and the measurements of the object to be cleaned (24). Compared to a selection to use a conventional cleaning bath corresponding to the cleaning objective and the measurements of the object to be cleaned (24), the storage unit (1) can be selected at a very low price and, along with saving of the cleaning liquid (3), an effective and inexpensive cleaning operation is possible.

Further, the cleaning operation can be performed for the aforementioned storage unit (1) arranged on multiple operation platforms (5) in a parallel manner. Through this structure, cleaning can be executed using multiple types of different cleaning liquids simultaneously so that a cleaning operation with high general versatility is possible.

1. A method for cleaning an object to be cleaned,
comprising the steps of:
mounting a storage unit, formed having an drain capable of draining out a cleaning liquid in the lower portion, on a mounting unit of an operation platform;
contacting in a tightly contacting manner at least an external lower portion of the drain of the storage unit and the mounting unit of the operation platform;
moving the storage unit from the mounting unit after the object to be cleaned is stored inside the storage unit and cleaned by the cleaning liquid along with the cleaning liquid being storable in the storage unit in a condition where the storage unit is mounted on the mounting unit;
dissolving the tight contact between the external lower portion of the drain and the mounting unit;
draining out the cleaning liquid from the drain; and
repeating the cleaning of the object to be cleaned by introducing the new cleaning liquid into the storage unit and once again contacting the object to be cleaned to the cleaning liquid after the storage unit is returned to the mounting unit.

2. A cleaning apparatus for an object to be cleaned,
wherein, along with forming a drain that can drain out a cleaning liquid in a lower portion of a storage body that can store the object to be cleaned, at least an external lower portion of the drain of the storage unit contacts a mounting unit of an operation platform in a tightly contacting manner;
wherein, along with being able to store the cleaning liquid inside the storage unit in a condition such that the storage unit is mounted on the mounting unit, a tight contact between the external lower portion of the drain and the mounting unit is dissolved at a time when the storage unit is moved from the mounting unit;
wherein the cleaning liquid is drained out from the drain;
wherein the storage unit is returned to the mounting unit after the cleaning liquid is drained out; and
wherein a new cleaning liquid can be introduced into the storage unit.

3. The method for cleaning an object to be cleaned according to claim 1, wherein the new cleaning liquid is made to flow by a connected liquid pump via the purification mechanism into the reservoir of drained cleaning liquid, and the cleaning liquid is purified by the purification mechanism and reused.

4. The cleaning apparatus for an object to be cleaned according to claim 2, wherein the new cleaning liquid is made to flow by a connected liquid pump via the purification mechanism into the reservoir of drained out cleaning liquid, and the cleaning liquid is purified by the purification mechanism and reused.

5. The method for cleaning an object to be cleaned according to claim 1, wherein the new cleaning liquid is not cleaning liquid purified after being used to clean the object to be cleaned, but rather is cleaning liquid that has yet to be used.

6. The cleaning apparatus for an object to be cleaned according to claim 2, wherein the new cleaning liquid is not cleaning liquid purified after being used to clean the object to be cleaned, but rather is cleaning liquid that has yet to be used.

7. The method for cleaning an object to be cleaned according to claim 1, 3, or 5, wherein the operation platform is statically disposed and set up inside a cleaning bath serving as the reservoir for storing the cleaning liquid drained out from the drain of the storage unit.

8. The cleaning apparatus for an object to be cleaned according to claim 2, 4, or 6, wherein the operation platform is statically disposed and set up inside a cleaning bath serving as the reservoir for storing the cleaning liquid drained out from the drain of the storage unit.

9. The method for cleaning an object to be cleaned according to claim 1, 3, or 5, wherein the operation platform is formed independently from the reservoir in a movable manner and can move to a location of the reservoir.

10. The cleaning apparatus for an object to be cleaned according to claim 2, 4, or 6, wherein the operation platform is formed independently from the reservoir in a movable manner and can move to a location of the reservoir.

11. The method for cleaning an object to be cleaned according to claim 1 or 3, wherein the reservoir is formed of multiple independent units filled with different cleaning liquids corresponding to a cleaning objective, the storage unit is sequentially connected to the multiple reservoirs, and the cleaning liquid is supplied to the object to be cleaned by a pump.

12. The cleaning apparatus for an object to be cleaned according to claim 2 or 4, wherein the reservoir is formed of multiple independent units filled with different cleaning liquids corresponding to a cleaning objective, the storage unit is sequentially connected to the multiple reservoirs, and the cleaning liquid is supplied to the object to be cleaned by a pump.

13. The method for cleaning an object to be cleaned according to claim 1, 3 or 5, wherein, on the operation platform, an ultrasonic oscillator is disposed on the mounting unit of the storage unit and, along with the cleaning liquid, the object to be cleaned that is stored in the storage unit can be ultrasonically cleaned.

14. The cleaning apparatus for an object to be cleaned according to claim 2, 4 or 6, wherein, on the operation platform, an ultrasonic oscillator is disposed on the mounting unit of the storage unit and, along with the cleaning liquid, the object to be cleaned that is stored in the storage unit can be ultrasonically cleaned.

15. The method for cleaning an object to be cleaned according to claim 1, wherein a roller having a diameter larger than a height of an external peripheral frame dividing the multiple successive operation platforms is disposed on the upper surface of the operation platform and the object to be cleaned can be moved by the roller.

16. The cleaning apparatus for an object to be cleaned according to claim 2, wherein a roller having a diameter larger than a height of an external peripheral frame dividing the multiple successive operation platforms is disposed on the upper surface of the operation platform and the object to be cleaned can be moved by the roller.

17. The method for cleaning an object to be cleaned according to claim 1, wherein the object to be cleaned that is stored in the storage unit is inserted into a storage basket.

18. The cleaning apparatus for an object to be cleaned according to claim 2, wherein the object to be cleaned that is stored in the storage unit is inserted into a storage basket.
